(19) United States
(12) Patent Application Publication
(10) Pub. No.: US 2008/0008804 A1
(43) Pub. Date: Jan. 10, 2008

(54) METHOD OF PROCESSING WHOLE POTATOES

(76) Inventor: KEN BROWN, REXBURG, ID (US)

Correspondence Address: DYKAS, SHAVER & NIPPER, LLP, P.O. BOX 877, BOISE, ID, 83701-0877, US

(21) Appl. No.: 11/456,498

(22) Filed: Jul. 10, 2006

(51) Int. Cl. A23B 4/06

(52) U.S. Cl. 426/509

(57) ABSTRACT

The invention is a process for processing whole unpeeled potatoes to result in a frozen potato which when cooked closely resembles a fresh potato cooked in a conventional oven. The process specifically restores moisture to a cooked potato and rehydrates the tissue and skin of the potato to counteract the effects of the cooking process.

### FIELD OF THE INVENTION

This invention generally relates to the processing of potato products and more specifically to a precooked frozen whole potato.

### BACKGROUND OF THE INVENTION

Potatoes are a very versatile food and all kinds of processed potato products have been created and have achieved great popularity. One type of potato product is a whole baked potato. These can be made in a conventional oven or in a microwave oven. However, it is very difficult to achieve an acceptable whole potato product as a frozen product. The advantage of a frozen product over a fresh potato which is baked in a conventional oven or a microwave oven is that it will have a much longer storage life than a whole potato and would cook more quickly than a whole potato.

There have been several attempts in the prior art to create a process for making a processed whole potato product. None of these have proven entirely satisfactory. In some cases, the processed potato is frozen, and invariably has an unattractive skin, or a wrinkled texture, or an unpleasant consistency. What is needed is a method for processing whole potatoes to create a frozen potato product which has the same properties and appearance as a whole potato cooked in a conventional oven, which is considered the optimum cooked whole potato.

### SUMMARY OF THE INVENTION

The invention is a method for processing potatoes to produce a pre cooked whole potato which is frozen for storage. When it is thawed and cooked, it has an appearance similar to a whole potato which has been cooked in a conventional oven. The process first includes the step of selecting, washing, and inspecting potatoes. These are typically USDA No. 1 grade potatoes which have been sized and sorted, and are washed and inspected using conventional techniques. The next step involves passing the selected potatoes into a heated environment with a temperature of approximately 350 degrees Fahrenheit. The heated environment can be a conventional oven, or a convection oven. The potatoes are kept in the heated environment of the oven for a period of time such that the core temperature of the potatoes reaches a temperature of approximately 185-200 degrees Fahrenheit. When the internal core temperature of the potatoes has reached that approximate temperature, the potatoes are removed from the heated environment and immediately contacted with water, which cools the potatoes. The water may be chilled to approximately 35-40 degrees Fahrenheit, but the temperature of the water can vary from 35 to about 60 degrees Fahrenheit. The potatoes can be cooled with water by several methods, including spraying, immersion, or preferably by a type of spray called a deluge. A deluge spray is a spray of water in which the water is conveyed in large droplets in a low-pressure stream.

The potatoes are in contact with the deluge of water for approximately 13-25 minutes. One purpose of the deluge is to remove heat from the potatoes and to stop the process of cooking. Another purpose of the deluge is to force water into the skin and tissue of the potato to replace water which had been lost in the cooking process. The low pressure of the spray is essential so that the skin of the potato is not damaged or removed by a higher-pressure spray.

The potatoes would typically be in contact with the deluge of water as they are transported on a belt, which could be a belt of rubber like material or a stainless steal belt of mesh or metal sections with holes.

The potatoes can be brought to the desired temperature in a heated environment which is formed in a convection oven, or a conventional oven. A heated environment as found in a food-processing oven such as a Proctor-Schwartz type oven which surrounds a continually moving belt with potatoes on the belt, is one type of heated environment which would work for the process. Another type which has been proven to be suitable for this method of potato processing is a batch process in which the potatoes are passed into a heated environment, held for a certain time in that environment and then removed in a batch process.

After the potatoes have been contacted with water for the prescribed period of time, they are conveyed to a refrigerated oven for freezing. The potatoes are brought to a frozen state over a period of time which can be from 30-60 minutes. There are undesirable results if they are frozen too quickly, and an optimum period over which to freeze the potatoes has been found to be about 45 minutes.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### DESCRIPTION OF THE PREFERRED EMBODIMENTS

The preferred embodiment of practicing the process of the invention is to start by selecting USDA No. 1 grade potatoes, and sizing and sorting those potatoes. They are then washed and inspected by conventional means. The next step involves passing the whole unpeeled potatoes into a heated environment in the form of a convection oven in which the temperature has been established at 350 degrees Fahrenheit.

The potatoes are retained in the heated environment of the convection oven for approximately 15 to 20 minutes which is sufficient time to heat the potatoes to an internal temperature of 185-200 degrees Fahrenheit, with 195 being the optimal temperature. At the end of this time period, or when the core temperature of the potatoes reaches the desired temperature, the potatoes are removed and subjected to a deluge of water. The deluge of water is in the form of a low-pressure spray of large sized water droplets. This deluge of water replaces the water that has been lost in the cooking process, and serves to make the potato tissue and especially the skin more plump and appealing to the user. This step serves to force water into the skin and flesh of the potatoes. The potatoes are held in the deluge of water for approximately 10-30 minutes with 15-20 minutes being the optimum.

After this period of time in the deluge of water, the potatoes are moved to a freezing chamber, in which the temperature of the potatoes is brought to freezing over a period of time, from 30-60 minutes, with 45 minutes being the optimal time to reach a freezing temperature. The freezing period is critical, and can't be accomplished too rapidly. The slow freezing period helps to smooth the skin of the potato, and give the frozen product the appearance of a fresh potato.

The potatoes can then be stored as frozen potatoes and prepared by the user by reheating, either in a microwave oven, conventional oven, or a convection oven.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A method for processing potatoes to produce a precooked whole potato, comprising the steps of;
selecting whole unpeeled potatoes for processing;
passing the selected potatoes into a heated environment with a temperature of 350 degrees Fahrenheit;
retaining the potatoes in the heated environment for a time sufficient to heat the core of the potatoes to a temperature of 187-207 degrees Fahrenheit;
removing the potatoes form the heated environment;
contacting the potatoes with chilled water at 30-45 degrees Fahrenheit to cool the potatoes to their core and stop any cooking, and to replace moisture lost during the heating step; and
conveying the cooled potatoes to a cooled environment for a slow temperature reduction to freezing, and leaving the potatoes in a frozen form from which they may be heated and have the appearance and consistency of a freshly baked potato.

2. The method for processing potatoes to produce a precooked whole potato of claim 1, in which the water chilling step includes contacting the potatoes by deluge in chilled water for a period of time.

3. The method for processing potatoes to produce a precooked whole potato of claim 2, in which the water chilling step includes contacting the potatoes by deluge in chilled water for 10 to 20 minutes.

4. The method for processing potatoes to produce a precooked whole potato of claim 1, in which the water chilling step includes contacting the potatoes by spraying chilled water on a belt for a period of time.

5. The method for processing potatoes to produce a precooked whole potato of claim 5, in which the water chilling step includes contacting the potatoes by spraying chilled water for 10 to 20 minutes.

6. The method for processing potatoes to produce a precooked whole potato of claim 1, in which the potatoes are retained in a heated environment in the form of a convection oven.

7. The method for processing potatoes to produce a precooked whole potato of claim 6, in which the potatoes are retained in a heated environment at 350 to 400 degrees Fahrenheit for 45 to 60 minutes.

8. The method for processing potatoes to produce a precooked whole potato of claim 1, in which the potatoes are retained in a heated environment in the form of a convection oven.

9. The method for processing potatoes to produce a precooked whole potato of claim 1, in which the slow freezing step is configured to reduce the potatoes to freezing in no more than 30 minutes.

10. The method for processing potatoes to produce a precooked whole potato of claim 1, in which the slow freezing step is configured to reduce the potatoes to freezing in no more than 45 minutes.

11. A method for processing potatoes to produce a precooked whole potato, comprising the steps of;
selecting whole unpeeled potatoes for processing;
passing the selected potatoes into a heated environment in a convection oven with a temperature of 350 degrees Fahrenheit;
retaining the potatoes in the heated environment for 45 to 60 minutes, or a time sufficient to heat the core of the potatoes to a temperature of 196-207 degrees Fahrenheit;
removing the potatoes from the heated environment;
contacting the potatoes with chilled water at 30-45 degrees Fahrenheit by deluge for 10 to 20 minutes to cool the potatoes to their core and stop any cooking, and to replace moisture lost during the heating step; and
conveying the cooled potatoes to a cooled environment for slow freezing over no less than a 40 minute period, and leaving the potatoes in a frozen form from which then may be heated and have the appearance and consistency of a freshly baked potato.
